(19) United States
(12) Patent Application Publication
(10) Pub. No.: US 2018/0335773 A1
(43) Pub. Date: Nov. 22, 2018

(54) BALANCING BOARD

(71) Applicant: Yi Xie, Los Angeles, CA (US)

(72) Inventor: Yi Xie, Los Angeles, CA (US)

(21) Appl. No.: 15/981,786

(22) Filed: May 16, 2018

Related U.S. Application Data
(60) Provisional application No. 62/506,768, filed on May 16, 2017.

(51) Int. Cl. G05D 1/00; B62K 11/00; G10L 15/22

(52) U.S. Cl. CPC G05D 1/0016; B62K 11/007; H04W 84/12; G10L 15/22; G05D 1/0022

(57) ABSTRACT

A balancing board may include a first and a second platform section. Each platform section may include a housing formed of a bottom housing member and a top housing member. The top housing members may have a foot placement section or area formed integrally therewith. In an exemplary embodiment, the balancing board has a wireless communicating module to function as a mobile communication device, and the user can communicate with the balancing board through a user interface. In one embodiment, the user control interface can communicate and control the wireless communicating module through infrared (IR), WI-FI or BLUETOOTH.

### CROSS-REFERENCE TO RELATED APPLICATIONS

This application claims priority under 35 U.S.C. § 119 (e) to U.S. Provisional Patent Application Ser. No. 62/506,768, filed on May 16, 2017, the entire contents of which are hereby incorporated by reference.

### FIELD OF THE INVENTION

The present invention relates to balancing boards, and more particularly to the balancing boards that can be remotely controlled by the user even when the user is not standing on the balancing board.

### BACKGROUND OF THE INVENTION

Personal vehicles may be self-propelled and user-guidable, and may entail stabilization in one or both of the fore-aft or left-right planes. Vehicles of this sort, as shown in FIG. 1, may be operated in a mode in which motion of the vehicle, including acceleration (both linear and turning), is controlled partially or entirely by leaning of the vehicle as caused by a subject riding the vehicle. Several such vehicles are described in U.S. Pat. No. 5,971,091 (“the '091 patent”), issued Oct. 26, 1999, which is incorporated herein by reference.

In recent years, electric transporters of the gyropode type person carriers equipped with electric motors and a gyroscopic technology are developed. The electric transporter enables the person to stand in balanced fashion on both parallel wheels without the user having to compensate for the instability caused by the center of gravity being out of plumb. Thus, the user is standing and does not need to place their foot on the ground either to balance or to advance.

More specifically, dynamically stabilized transporters refer to personal transporters having a control system that actively maintains the stability of the transporter while the transporter is operating. The control system maintains the stability of the transporter by continuously sensing the orientation of the transporter, determining the corrective action to maintain stability, and commanding the wheel motors to make the corrective action.

U.S. Pat. No. 8,738,278 (“the '278 patent”) to Chen discloses a two-wheel, self-balancing personal vehicle having independently movable foot placement sections. The foot placement sections have an associated wheel, sensor and motor and are independently self-balancing which gives the user independent control over the movement of each platform section by the magnitude and direction of tilt a user indices in a given platform section.

However, in conventional transporters in the '091 patent or self-balancing vehicles in the '278 patent, the user has to personally stand on them to control the movement thereof. When the user leaves the device, the user has almost no control of the device. Also, neither the '091 nor the '278 patents discloses using the transporter or balancing vehicle as a communication device such as a cell phone. Therefore, there remains a need for a new and improved transporter or self-balancing board to overcome the problems stated above and achieve the goal of “hands free” when talking over the mobile communication device.

### SUMMARY OF THE INVENTION

It is an object of the present invention to provide a balancing board that can be controlled by the user even when the user is not standing on the board.

It is another object of the present invention to provide a balancing board having a communication module that can be used to communicate with a user control interface, so the user can remotely control the balancing board without standing on it.

It is a further object of the present invention to provide a balancing board that can be used as a mobile communication device such as a cellular phone that may be coupled with a communication glasses to serve all purposes of existing cellular phones.

In one aspect, a balancing board may include a first and a second platform section. Each platform section may include a housing formed of a bottom housing member and a top housing member. The top housing members may have a foot placement section or area formed integrally therewith or affixed thereon. The foot placement section is preferably of sufficient size to receive the foot of a user and may include a tread or the like for traction and/or comfort.

The housing may be formed of metal, sturdy plastic or other suitable material. The housing members may be molded and incorporate strengthening reinforcements, and be shaped to receive and “nest” the internal components of the vehicle. The bottom and top housing sections are formed complementarily so that after the internal components are installed, the top housing section is fitted onto the bottom housing section and secured with screws or other fasteners. Each platform section includes a wheel, and each wheel preferably has an axle and motorized hub assembly, which are known in the art.

In one embodiment, each platform section preferably includes a position sensor, which may be a gyroscopic sensor, for independent measurement of the position of the respective platform section. The sensors are preferably mounted on circuit boards that may be attached to the interior of the respective bottom housings. The sensors are preferably mounted on circuit boards that may be attached to the interior of the respective bottom housings. Sensed position information from sensor is used to drive the corresponding motor and wheel. The control logic for translating position data to motor drive signals may be centralized or split between the two platform sections. For example, the control logic may be electrically connected to sensors and to drive motors, electrical conduits connecting through the connecting shaft between sensors, control logic, and motors.

Communication between these components is primarily in the direction of data from the sensor and drive signals to the motor. However, communication in the other direction may include start signals (i.e. to the sensor), status signals (i.e. from the motor indicating an unsafe condition (e.g. excessive rpm), or a motor/drive failure or irregularity). This information, in addition to battery information, etc., could be communicated back to a user via lights or another interface, or communicated wirelessly (e.g. blue-tooth) from the vehicle to a hand-held device such as a mobile phone. In addition, if the platform sections have separate and independent control logic, these processing units may still share information with one another, such as status, safe operation information, etc.

In one embodiment, the two platform sections are movably coupled to one another with the shaft about which they may rotate (or pivot with respect to one another). Brackets and flange brackets may secure the shaft to the platform sections, with the flange brackets preferably configured to prevent or reduce the entry of dirt or moisture within the housings. The shaft may be hollow in part and thereby allowing for the passage of conduits therethrough. Pivoting or rotating shaft arrangements are known in the art, and others may be used without deviating from the present invention as long as the foot placement sections may move independently.

In an exemplary embodiment, the balancing board has a wireless communicating module to communicate with the user. More specifically, the user may have a corresponding user control interface to communicate and control the balancing board within a predetermined distance. In one embodiment, the user control interface can communicate and control the wireless communicating module through infrared (IR). In another embodiment, the user control interface can communicate and control the wireless communicating module through WI-FI.

For example, when the user is walking and the balancing board is within a predetermined distance from the user, the user can remotely control the balancing board through the user control interface. More specifically, the user control interface can send a signal to the balancing board through the wireless communicating module to start the motors and the wheels, so the balancing board can independently move without the user standing on it.

In another embodiment, the balancing board may include a motion sensor to detect the user's motion, and when the motion sensor detects a pre-stored motion from the user, the motion sensor may transmit such information to the motors and the wheels through the wireless communicating module to trigger the balancing board to make certain movement.

In another aspect, the balancing board can be directly used as a mobile communication device such as a smart phone through the wireless communicating module. In one embodiment, the user interface can be a glasses wore by the user and the lenses of the glasses can be used as the screen of the cellular phone to display information or message for the user.

In one embodiment, the user interface can communicate and control the wireless communicating module through infrared (IR). In another embodiment, the user interface can communicate and control the wireless communicating module 360 through WI-FI. In a further embodiment, the user interface can communicate and control the wireless communicating module through BLUETOOTH.

To control the balancing board as the mobile communication device, in one embodiment, the user can send a voice command such as “text John I will call back” or “call office” to the balancing board just as controlling traditional mobile communication device with hands. More specifically, the voice command can be recognized through a voice recognition unit to recognize and analyze the voice command to control the balancing board correctly.

### BRIEF DESCRIPTION OF THE DRAWINGS

FIG. 1 is a prior art disclosing a transportation vehicle for transporting individuals over ground having a surface that may be irregular.

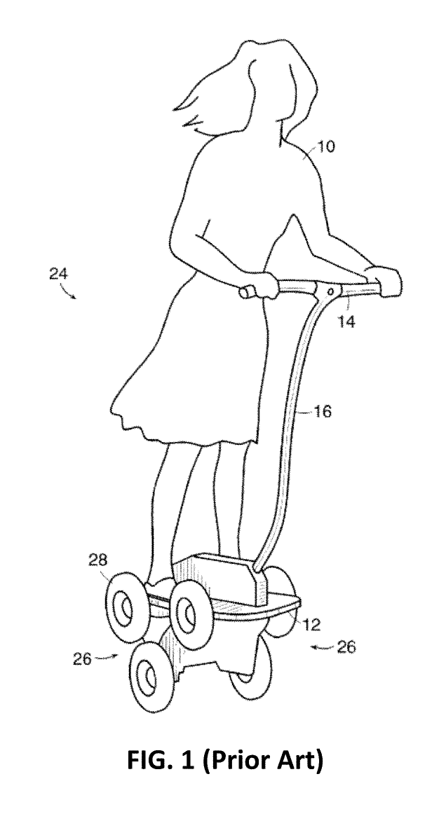

FIG. 2 is a prior art disclosing a two-wheel, self-balancing personal vehicle having independently movable foot placement sections.

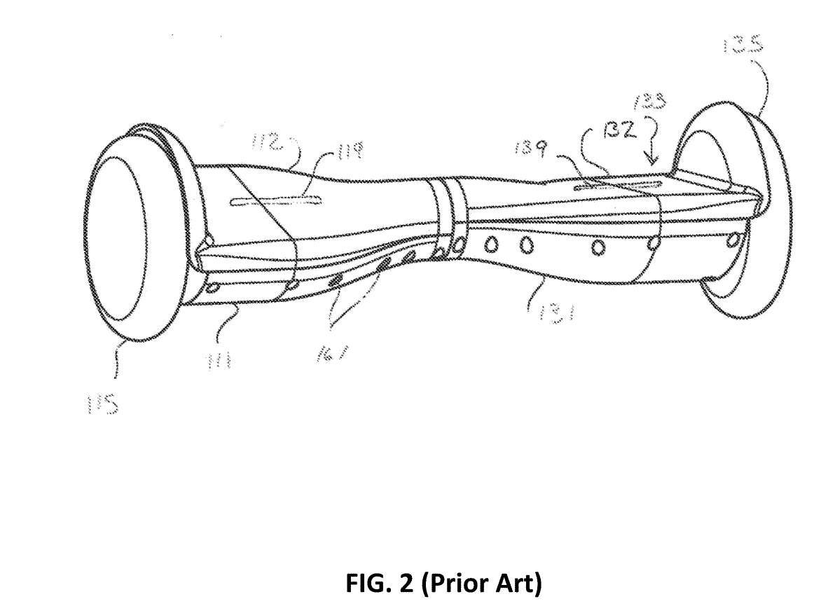

FIG. 3 illustrates a schematic view of a balancing board in the present invention.

FIG. 4 illustrates a block diagram of the balancing board in FIG. 3 in the present invention.

FIG. 5 illustrates a schematic view of one embodiment of the balancing board in the present invention.

FIG. 6 illustrates a schematic view of another embodiment of the balancing board in the present invention.

FIG. 7 illustrates a block diagram of the balancing board in FIG. 6 in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

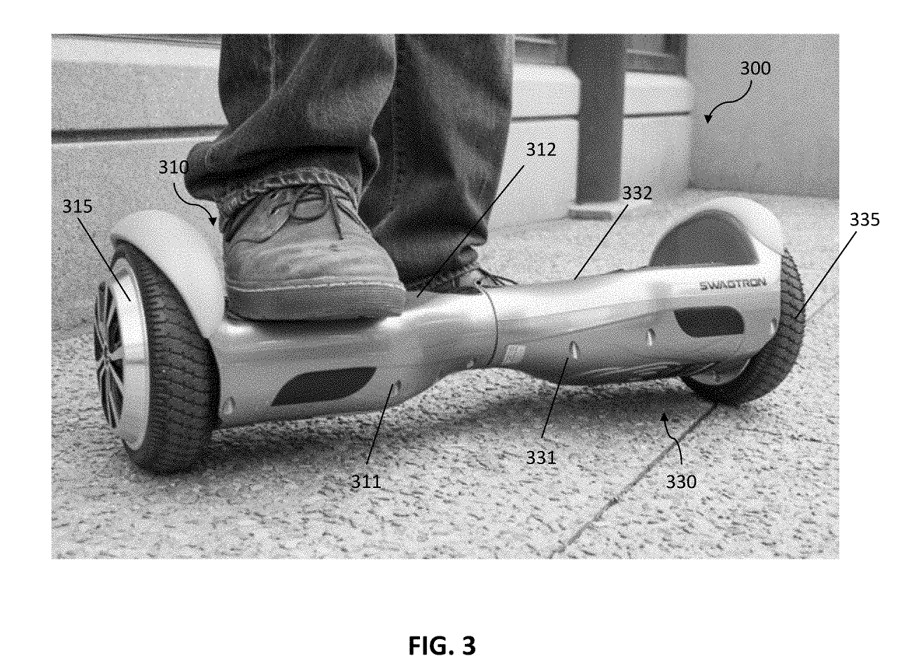

In one aspect, as shown in FIG. 3, a balancing board 300 may include a first and a second platform section 310 and 330. Each platform section (310, 330) may include a housing formed of a bottom housing member (311, 331) and a top housing member (312, 332). The top housing members may have a foot placement section or area (313, 333) formed integrally therewith or affixed thereon. The foot placement section is preferably of sufficient size to receive the foot of a user and may include a tread or the like for traction and/or comfort.

The housing may be formed of metal, sturdy plastic or other suitable material. The housing members may be molded and incorporate strengthening reinforcements, and be shaped to receive and “nest” the internal components of the vehicle. The bottom and top housing sections are formed complementarily so that after the internal components are installed, the top housing section is fitted onto the bottom housing section and secured with screws or other fasteners. Each platform section includes a wheel (315, 335), and each wheel preferably has an axle and motorized hub assembly, which are known in the art.

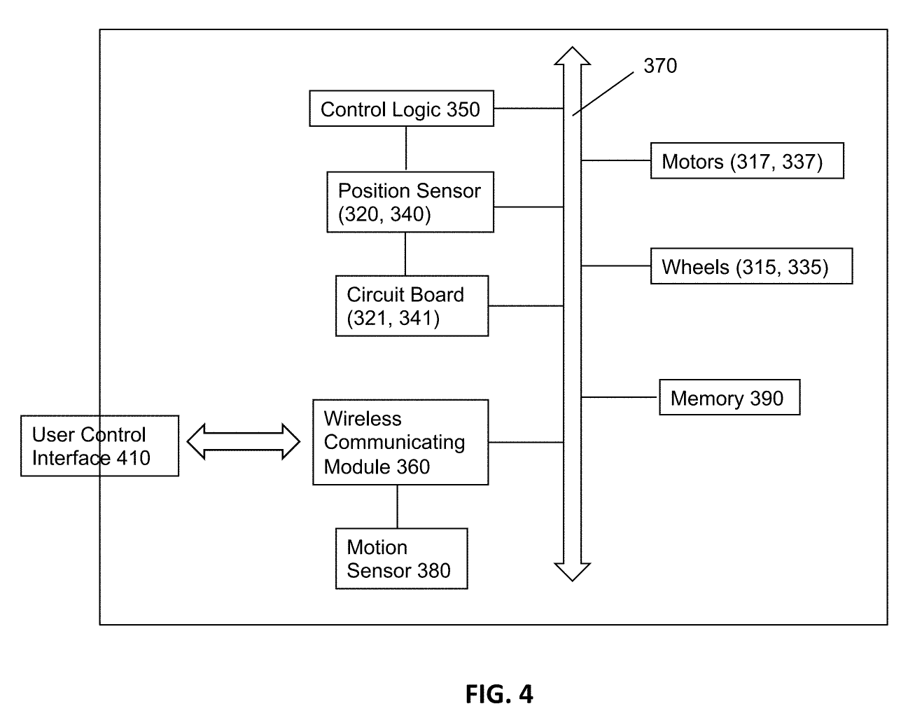

In one embodiment, as shown in FIG. 4, each platform section preferably includes a position sensor (320, 340), which may be a gyroscopic sensor, for independent measurement of the position of the respective platform section. The sensors are preferably mounted on circuit boards that may be attached to the interior of the respective bottom housings. The sensors are preferably mounted on circuit boards (321, 341) that may be attached to the interior of the respective bottom housings. Sensed position information from sensor (320, 340) is used to drive the corresponding motor (317, 337) and wheel (315, 335). The control logic 350 for translating position data to motor drive signals may be centralized or split between the two platform sections. For example, the control logic 350 may be electrically connected to sensors (320, 340) and to drive motors (317, 337), electrical conduits connecting through the connecting shaft 370 between sensors (320, 340), control logic 350, and motors (317, 337).

Communication between these components is primarily in the direction of data from the sensor and drive signals to the motor. However, communication in the other direction may include start signals (i.e. to the sensor), status signals (i.e. from the motor indicating an unsafe condition (e.g. excessive rpm), or a motor/drive failure or irregularity). This information, in addition to battery information, etc., could be communicated back to a user via lights or another interface, or communicated wirelessly (e.g. blue-tooth) from the vehicle to a hand-held device such as a mobile phone. In addition, if the platform sections have separate and independent control logic 350, these processing units may still share information with one another, such as status, safe operation information, etc.

In one embodiment, as shown in FIG. 3, the two platform sections (310, 330) are movably coupled to one another with the shaft 370 about which they may rotate (or pivot with respect to one another). Brackets and flange brackets may secure the shaft to the platform sections, with the flange brackets preferably configured to prevent or reduce the entry of dirt or moisture within the housings. The shaft 370 may be hollow in part and thereby allowing for the passage of conduits therethrough. Pivoting or rotating shaft arrangements are known in the art, and others may be used without deviating from the present invention as long as the foot placement sections may move independently.

In an exemplary embodiment, the balancing board 300 has a wireless communicating module 360 to communicate with the user. More specifically, the user may have a corresponding user control interface 410 to communicate and control the balancing board 300 within a predetermined distance. In one embodiment, the user control interface 410 can communicate and control the wireless communicating module 360 through infrared (IR). In another embodiment, the user control interface 410 can communicate and control the wireless communicating module 360 through WI-FI. In a further embodiment, the user control interface 410 can communicate and control the wireless communicating module 360 through BLUETOOTH.

For example, when the user is walking and the balancing board 300 is within a predetermined distance from the user, the user can remotely control the balancing board 300 through the user control interface 410. More specifically, the user control interface 410 can send a signal to the balancing board 300 through the wireless communicating module 360 to start the motors (317, 337) and the wheels (315, 335), so the balancing board 300 can independently move without the user standing on it.

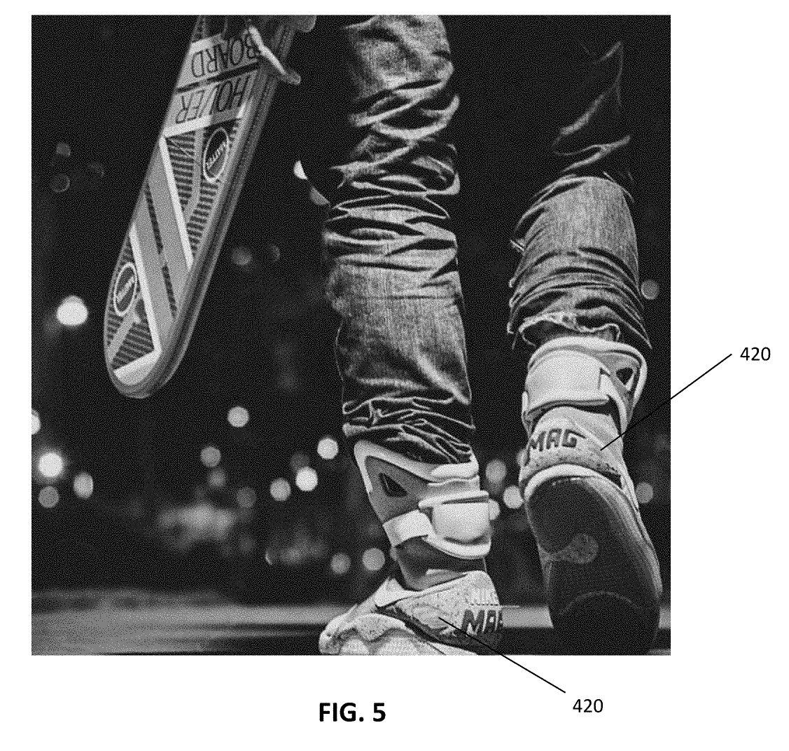

In another embodiment, the balancing board 300 may include a motion sensor 380 to detect the user's motion, and when the motion sensor 380 detects a pre-stored motion from the user, the motion sensor 380 may transmit such information to the motors (317, 337) and the wheels (315, 335) through the wireless communicating module 360 to trigger the balancing board 300 to make certain movement. For example, the motion sensor 380 detects the user's left foot stomps on the ground twice, which is a pre-stored motion in memory 390 and corresponding to a specific movement of the balancing board 300 (e.g. moving around the user twice), the result of the detection may be transmitted to the motors (317, 337) and wheels (315, 335) of the balancing board 300 to move around the user twice. In a further embodiment, a pair of corresponding motion sensors 420 may be disposed on the user's shoes as shown in FIG. 5, so it may be easier for the motion sensor 380 on the balancing board 300 to detect the motion of the user through the corresponding motion sensors 420.

In still a further embodiment, the user control interface 410 may be a smart phone that can be paired with the balancing board 300 through Bluetooth protocol for example. When the smart phone plays a specific music that is pre-stored in the memory 390 in the balancing board 300, the balancing board 300 may be triggered to make some specific movement as it is triggered by the user's specific movement.

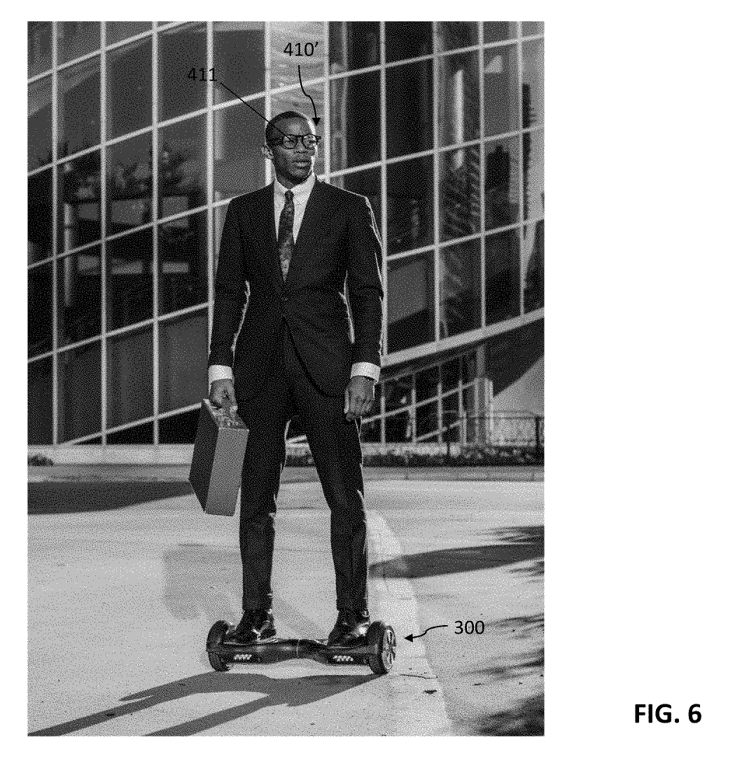

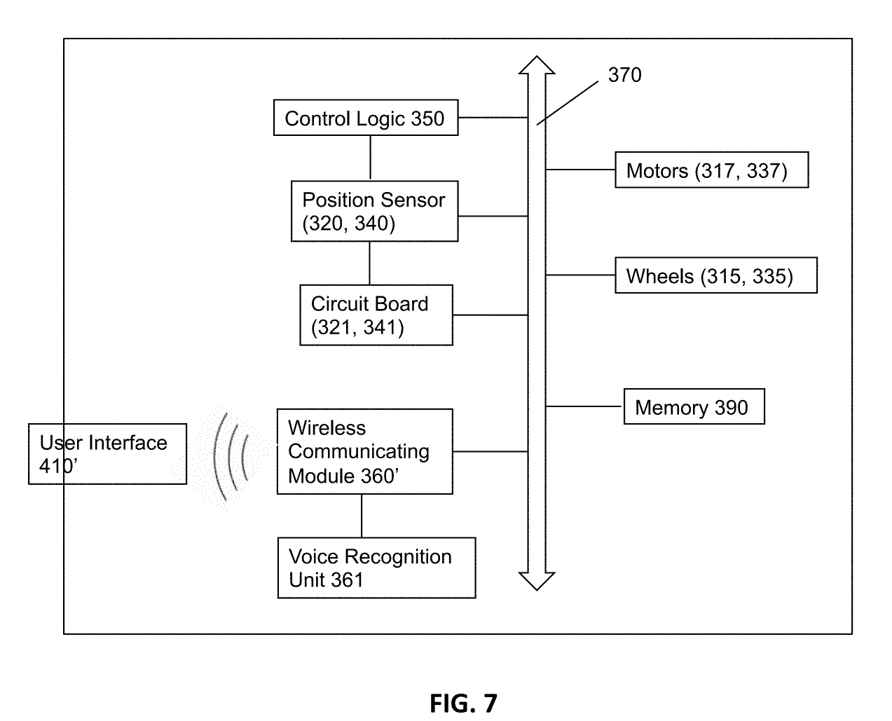

In another aspect, as shown in FIGS. 6 and 7, the balancing board 300 can be directly used as a mobile communication device such as a smart phone through the wireless communicating module 360′ that can be used to receive and transmit communication signals. In one embodiment, a user interface 410′ can be a multi-functional glasses wore by the user that can be communicatively coupled with the wireless communicating module 360′ and the lenses 411 of the glasses 410′ can be used as the screen of the cellular phone to display information or message for the user. The glasses 410′ may further include a headset and microphone so the user can hear the voice from the other side and talk over the microphone.

In one embodiment, the user interface 410 can communicate and control the wireless communicating module 360 through infrared (IR). In another embodiment, the user interface 410 can communicate and control the wireless communicating module 360 through WI-FI. In a further embodiment, the user interface 410 can communicate and control the wireless communicating module 360 through BLUETOOTH.

To control the balancing board 300 as the mobile communication device, in one embodiment, the user can send a voice command such as “text John I will call back” or “call office” to the balancing board 300 just as controlling traditional mobile communication device with hands. More specifically, the voice command can be recognized through a voice recognition unit 361 to recognize and analyze the voice command to control the balancing board correctly.

Using the balancing board 300 as the mobile communication device is advantageous because it serves the purpose of “hands free.” No matter how light or small the mobile communication device is, the user still has to hold it when talking with someone over it. When one hand the user has been occupied with a suitcase (as shown in FIG. 6) and the other hand has to hold the mobile communication device to talk, the user may be too overwhelmed when something urgent happens. Thus, switching the “hand-held” mobile communication device to the balancing board 300 coupled with a user interface 410′ can literally replace traditional cellular phones to free the user's hands.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. A transporter comprising:
a user interface;
a wireless communication module communicatively coupled with the user interface; and
a first and a second platform section movably coupled with each other with a shaft about which the first and second platform sections can rotate, each platform section including at least a wheel and a housing formed of a bottom housing member and a top housing member, said top housing members having a foot placement section formed integrally therewith or affixed thereon, and
at least one electric motor to power the transporter,
wherein the wireless communication module is configured to receive and transmit communication signals and the user interface is configured to convert the communication signals to readable messages and display to a user.

2. The transporter of claim 1, further comprising a motion sensor to detect the user's motion, and when the motion sensor detects a pre-stored motion from the user, the motion sensor is configured to transmit such information to the electric motor and wheel.

3. The transporter of claim 1, wherein the user interface is a multi-functional glasses and the message to the user can be displayed on at least one lenses of the multi-functional glasses.

4. The transporter of claim 1, wherein the user interface can communicate and the wireless communicating module through infrared (IR), WI-FI or BLUETOOTH.

5. The transporter of claim 1, wherein the user interface includes a headset and microphone so the user can hear the voice from the other side and talk over the microphone.

6. The transporter of claim 1, further comprising a voice recognition unit to recognize the user's voice commands to enable the user to control the transporter.
